(19) United States
(12) Patent Application Publication
(10) Pub. No.: US 2013/0335274 A1
(43) Pub. Date: Dec. 19, 2013

(54) WIRELESS COMMUNICATION DEVICE WITH ANTENNA STRUCTURE

(71) Applicants: SHIH-PO LO, NEW TAIPEI CITY (TW); SU-HUAN YU, NEW TAIPEI CITY (TW); YI-FA KUO, NEW TAIPEI CITY (TW)

(72) Inventors: SHIH-PO LO, NEW TAIPEI CITY (TW); SU-HUAN YU, NEW TAIPEI CITY (TW); YI-FA KUO, NEW TAIPEI CITY (TW)

(73) Assignee: ASKEY COMPUTER CORP.

(21) Appl. No.: 13/604,676

(22) Filed: Sep. 6, 2012

(30) Foreign Application Priority Data
Jun. 13, 2012 (TW) 101121079

(51) Int. Cl. H01Q 1/38

(52) U.S. Cl. 343/700 MS

(57) ABSTRACT

A wireless communication device with an antenna structure includes a wireless communication device body and an antenna. The antenna includes a first flexible laminate substrate, a second flexible laminate substrate, and an antenna metal layer. The antenna is disposed on a surface of a case of the wireless communication device body through the second flexible laminate substrate. The antenna metal layer is disposed between and is in contact with the first flexible laminate substrate and the second flexible laminate substrate. With the antenna disposed on the surface of the case of the wireless communication device, it is feasible to reduce the space required to accommodate an internal circuit of the wireless communication device, enhance the efficiency of the antenna for transmitting and receiving signals, and display any pattern on the outer surface of the antenna.

### CROSS-REFERENCE TO RELATED APPLICATION

This non-provisional application claims priority under 35 U.S.C. §119(a) on Patent Application No(s). 101121079 filed in Taiwan, R.O.C. on Jun. 13, 2012, the entire contents of which are hereby incorporated by reference.

### FIELD OF TECHNOLOGY

The present invention relates to a wireless communication device with an antenna structure, in particular to the wireless communication device with an antenna installed on an outer surface of a case.

### BACKGROUND

As wireless communication blooms and various communication products tend to be developed with a compact portable design, the position and the space for installing an antenna in the wireless communication device have more limitations, and thus making the design of the antenna in the wireless communication device more difficult.

In the various different wireless communication devices, there is a wireless communication device having an antenna with related circuits designed on a main circuit board inside the wireless communication device, but such arrangement results in a relatively larger circuit board and requires a reserved space for the wiring of the circuit, so that it is relatively more difficult to reduce the dimensions of the wireless communication device. If a flexible circuit board is used for installing the antenna related circuit instead, a reserved space inside the wireless communication device is still required for installing the antenna related circuit.

No matter which kind of circuit boards is used for installing the antenna related circuit of the wireless communication device, signal interference may occur in addition to the aforementioned limitation of internal space. More specifically, the circuit of the antenna structure is very close to other control processing circuits inside the wireless communication device, so that signals between the two circuits may have electromagnetic interferences with each other, not only producing noises to the transmitted or received signals of the antenna, but also having the possibility of creating errors to the control processing signal of the internal circuit and resulting in a poor operation of the wireless communication device.

### SUMMARY

It is a primary objective of the present invention to provide a flexible antenna structure capable of enhancing the signal transmitting and receiving functions of the antenna and preventing the signals from being affected by electromagnetic interference produced by internal circuits of the wireless communication device.

Another objective of the present invention is to provide a wireless communication device with an antenna structure capable of forming a trademark, a text or a symbol directly onto the antenna to provide an aesthetic appearance of the antenna.

To achieve the aforementioned and other objectives, the present invention provides a wireless communication device with an antenna structure, comprising: a wireless communication device body and an antenna, wherein the wireless communication device body has a case, and a control processing circuit installed therein, and the antenna is installed on a surface of the case. Wherein, the antenna includes a first flexible laminate substrate, a second flexible laminate substrate installed on a surface of the case, and an antenna metal layer disposed between the first flexible laminate substrate and the second flexible laminate substrate and contacted with the first flexible laminate substrate and the second flexible laminate substrate.

In a preferred embodiment, the first flexible laminate substrate and the second flexible laminate substrate are made of polycarbonate (PC), polyvinyl chloride (PVC), polystyrene (PS) or mylar.

In a preferred embodiment, the first flexible laminate substrate has a pattern formed on a surface opposite to the antenna metal layer. The first flexible laminate substrate has a pattern formed on a surface opposite to the antenna metal layer. Wherein, the pattern is formed on the first flexible laminate substrate by printing, bronzing, hair-lining, etching, polishing, sand blasting, transprinting, spray-coating or Boli processing.

In a preferred embodiment, the case further includes a slot for installing the antenna.

In a preferred embodiment, the antenna further includes a flexible circuit board installed on the first flexible laminate substrate, and having at least one electronic component embedded into the flexible circuit board, and each of the first flexible circuit board and the second flexible laminate substrate has a corresponding through hole, and the at least one electronic component is electrically coupled to the interior of the case of the wireless communication device through the corresponding through holes of the first flexible laminate substrate and the second flexible laminate substrate.

Wherein, the flexible circuit board is an operation or indication panel of the wireless communication device.

Compared with the prior art, the antenna of the present invention is installed on an outer surface of the case of the wireless communication device to reduce the area of the circuit board for the circuit layout of the wireless communication device and prevent the transmitted and received signals of the antenna from being interfered by the internal circuits, or the antenna even provides other functions including pattern display or operation interface, so that the volume of the wireless communication device can be reduced significantly, and the invention can provide sensitive operations and additional effects to meet both user and industrial requirements.

### BRIEF DESCRIPTION OF THE DRAWINGS

FIG. 1 is a partial cross-sectional view of an antenna of a wireless communication device in accordance with a preferred embodiment of the present invention;

FIG. 2 is an exploded view of an antenna of a wireless communication device in accordance with a preferred embodiment of the present invention; and

FIG. 3 is an exploded view of an antenna of a wireless communication device in accordance with another preferred embodiment of the present invention.

### DETAILED DESCRIPTION

The objects, characteristics and effects of the present invention will become apparent with the detailed description of the preferred embodiments and the illustration of related drawings as follows.

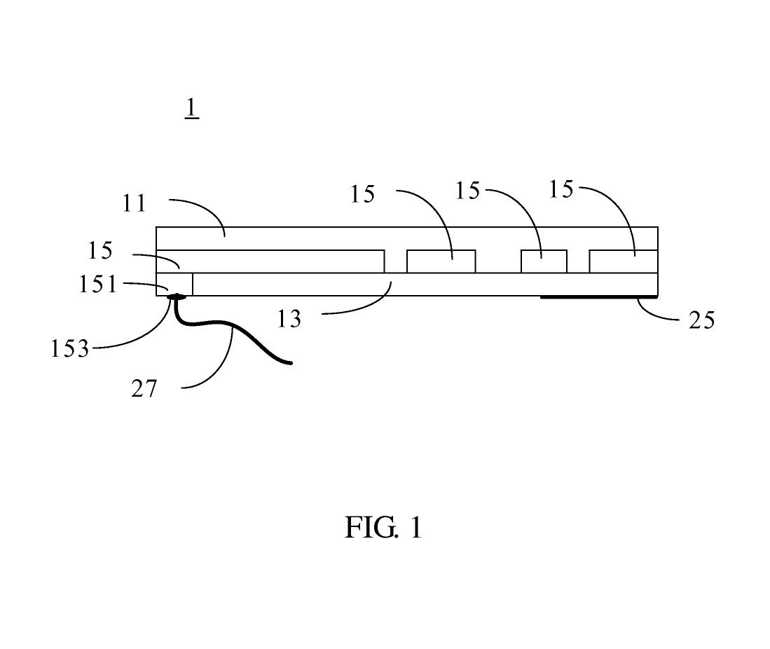

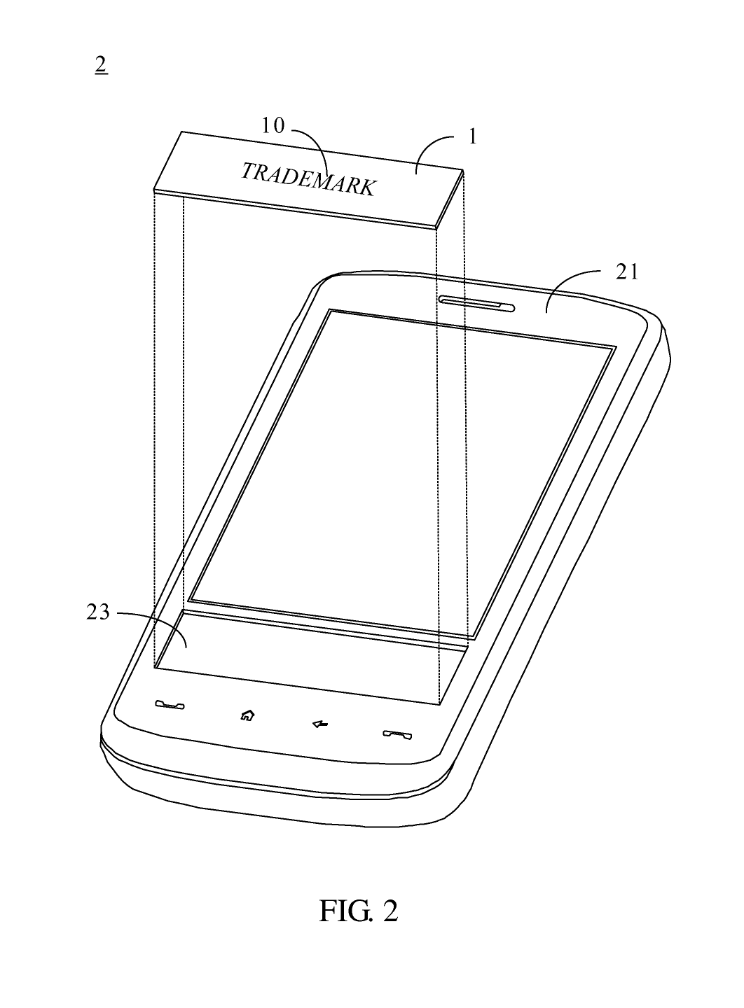

With reference to FIGS. 1 and 2 for a partial cross-sectional view and an exploded view of an antenna of a wireless communication device in accordance with a preferred embodiment of the present invention respectively, the antenna 1 comprises a first flexible laminate substrate 11, a second flexible laminate substrate 13 and an antenna metal layer 15.

The antenna 1 is installed on a surface of a case 21 of the wireless communication device 2. In FIGS. 1 and 2, the antenna 1 of this preferred embodiment is attached onto the surface of the case 21 of the wireless communication device 2 by the second flexible laminate substrate 13, and the antenna metal layer 15 is disposed between the first flexible laminate substrate 11 and the second flexible laminate substrate 13, and the antenna metal layer 15 is in contact with the first flexible laminate substrate 11 and the second flexible laminate substrate 13.

Therefore, a side opposite to the contact side of the first flexible laminate substrate 11 and the antenna metal layer 15 is aligned outwardly and provided for forming a trademark, a text or a symbol onto the first flexible laminate substrate 11 directly to achieve an aesthetic antenna of this preferred embodiment of the present invention.

In another preferred embodiment, a slot 23 is formed on the surface of the case 21 of the wireless communication device 2 and provided for installing the antenna 1 therein. Wherein, the slot 23 serves as a space for installing the antenna 1 as shown in FIG. 2. In actual implementations, the slot 23 is not absolutely necessary, since the antenna 1 can be attached onto the surface of the case 21 of the wireless communication device 2 directly.

The antenna 1 can be attached by the following methods. For example, an adhesive 25 is applied to a part of the whole bottom surface of the second flexible laminate substrate 13 for attaching the antenna 1 onto a surface of the case 21; or the antenna 1 is snapped into the slot 23 formed on the surface of the case 21 of the wireless communication device 2; or both methods of applying adhesive 25 and snapping the antenna 1 into the slot 23 can be used at the same time. However, these methods are provided as examples for illustrating the way of attaching the antenna 1, and the invention is not limited to these methods only, and thus any other equivalent method of attaching the antenna 1 onto the surface of the case 21 of the wireless communication device 2 can be used in the present invention.

The antenna metal layer 15 is made of metal; for example, the antenna metal layer 15 is formed by etching a copper foil.

In FIG. 1, the antenna metal layer 15 has a connection portion 151 for electrically connecting the antenna 1 to a control processing circuit substrate in the wireless communication device 2. In a preferred embodiment, the connection portion 151 is coupled to a metal wire 27 by a solder 153 (In other preferred embodiment, a port can be used for the electric connection, and the metal wire 27 is passed through the case 21 and electrically coupled to the control processing circuit substrate in the wireless communication device 2 (wherein the electric connection is not shown in the figure). Since the antenna 1 is installed on the surface of the case 21 of the wireless communication device 2, therefore the control processing circuit substrate has relatively less signal interference to the antenna 1.

In the preferred embodiment as shown in FIG. 2, a pattern 10 is directly formed or printed on a surface opposite to the contact surface of the first flexible laminate substrate 11 and the antenna metal layer 15, so that the antenna 1 of this preferred embodiment can have both displaying and indicating functions. The pattern 10 can be formed by the conventional methods such as front-side printing, back-side printing, bronzing, hair-lining, etching, polishing, sand blasting, transprinting, spray-coating or Boli processing. The aforementioned pattern can be any pattern, text, symbol or trademark, so that the invention has the functions of integrating pattern display/indication with the antenna.

In another preferred embodiment, the antenna metal layer 15 is etched and formed, and then a pattern is formed on the surface of the first flexible laminate substrate 11 opposite to the antenna metal layer 15, and then the first flexible laminate substrate 11, the antenna metal layer 15 and the second flexible laminate substrate 13 are hot pressed, or the first flexible laminate substrate 11, the antenna metal layer 15 and the second flexible laminate substrate 13 are hot pressed, and then the pattern 10 is formed on a surface of the first flexible laminate substrate 11 opposite to the antenna metal layer 15.

In this preferred embodiment, the first flexible laminate substrate 11 and the second flexible laminate substrate 13 are made of polycarbonate (PC), polyvinyl chloride (PVC), polystyrene (PS) or mylar. However, the material used for making the first and second laminate substrates 11, 13 is not limited to those given above, and the persons skilled in the art should be able to adopt an appropriate equivalent material for making the flexible laminate substrates.

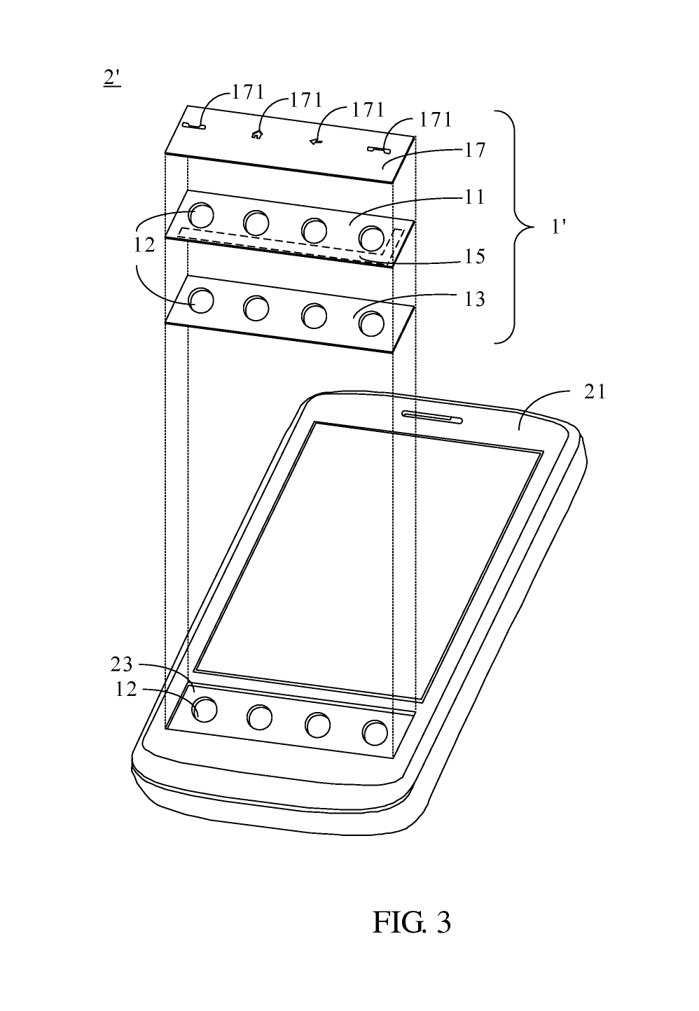

With reference to FIG. 3 for an exploded view of an antenna of a wireless communication device in accordance with another preferred embodiment of the present invention, the antenna 1′ further comprises a flexible circuit board 17, in addition to the first flexible laminate substrate 11, the second flexible laminate substrate 13 and the antenna metal layer 15.

The flexible circuit board 17 is installed on the first flexible laminate substrate 11, and the flexible circuit board 17 is an operation or indication panel of the wireless communication device 2′. More specifically, the flexible circuit board 17 includes at least one electronic component embedded therein and a circuit (not shown in the figure) electrically coupled to the at least one electronic component. In FIG. 3, the at least one electronic component is a four-key membrane keypad 171, and the corresponding through holes 12 formed on the first flexible laminate substrate 11 and the second flexible laminate substrate 13 are provided for passing the case 21 of the wireless communication device 2′ and electrically connecting to the control processing circuit substrate (not shown in the figure). Wherein, the flexible circuit board 17 can be used together with the first flexible laminate substrate 11 having the pattern. For example, the flexible circuit board 17 is a transparent substrate that can show the pattern formed on the first flexible laminate substrate 11 below.

It is noteworthy to point out that the antenna metal layer 15 of this preferred embodiment is not disposed at the through hole 12, but it is disposed at the periphery of the through hole 12 to avoid the through hole 12. For example, the aforementioned antenna metal layer 15 is disposed in the L-shaped area enclosed by a dotted line as shown in FIG. 3. Of course, other designs (designed according to specific requirements or specific appearance of an electronic component) can be adopted, and the installation position of the antenna or the shape of the block can be changed flexibly as long as the circuits of the electronic component are not interfered.

In view of the description above, the design of the flexible circuit board 17 of this preferred embodiment further provides a control/operation function of the antenna 1′. In other implementation modes, a combination of other electronic components or different electronic components can be adopted. For example, the at least one electronic component can be a set of four light emitting diodes (not shown in the figure) used as displays; or can be combined with the LED and the aforementioned membrane keypad, so that users can operate the keypad in a dark environment.

In the foregoing preferred embodiment, the plate body of the antenna is in a rectangular shape. Of course, the shape of the antenna can be changed in other implementation mode according to the actual requirements of the wireless communication device, and the interior design of the antenna metal layer can be adjusted to change the etched pattern.

In the foregoing preferred embodiment, the mobile phone is used as an example for illustrating the wireless communication device with the antenna of the present invention. Of course, those skilled in the art can easily think of other implementation modes of the antenna of the wireless communication device such as a wireless mouse, a wireless keyboard, a PDA, a notebook computer, an automatic signal return device, or any other equivalent electronic device with an antenna.

In summation of the description above, the present invention provide an antenna installed on an outer surface of a wireless communication device case, and the antenna is designed at a position outside the wireless communication device to save the space occupied by related circuits of the antenna inside the wireless communication device, so that the wireless communication device can have a smaller volume and a lighter weight and provide a better and smoother wireless communication effect. In addition, the manufacturers and sellers of the wireless communication device can label the contents of the wireless communication device such as a trademark, a product name or a part number on a surface of the antenna. The invention not only provides more functions of the antenna, but also simplifies pattern labeling elements required by the wireless communication device and replaces the conventional way of labeling the wireless communication device by a plastic name plate, so as to lower the production cost of the wireless communication device and improve the competitiveness of the wireless communication device.

While the invention has been described by means of specific embodiments, numerous modifications and variations could be made thereto by those skilled in the art without departing from the scope and spirit of the invention set forth in the claims.

What is claimed is:

1. A wireless communication device with an antenna structure, comprising:
a wireless communication device body, having a case, and a control processing circuit installed therein; and
an antenna, installed on a surface of the case, and including:
a first flexible laminate substrate;
a second flexible laminate substrate, installed on a surface of the case; and
an antenna metal layer, disposed between the first flexible laminate substrate and the second flexible laminate substrate and contacted with the first flexible laminate substrate and the second flexible laminate substrate.

2. The wireless communication device of claim 1, wherein the first flexible laminate substrate and the second flexible laminate substrate are made of a material selected from the collection of polycarbonate (PC), polyvinyl chloride (PVC), polystyrene (PS) and mylar.

3. The wireless communication device of claim 1, wherein the first flexible laminate substrate has a pattern formed on a surface opposite to the antenna metal layer.

4. The wireless communication device of claim 3, wherein the pattern is formed on the first flexible laminate substrate by a method selected from the collection of printing, bronzing, hair-lining, etching, polishing, sand blasting, transprinting, spray-coating and Boli processing.

5. The wireless communication device of claim 1, wherein the case further includes a slot for installing the antenna.

6. The wireless communication device of claim 1, wherein the antenna further includes a flexible circuit board installed on the first flexible laminate substrate, and having at least one electronic component embedded into the flexible circuit board, and each of the first flexible circuit board and the second flexible laminate substrate has a corresponding through hole, and the at least one electronic component is electrically coupled to the interior of the case of the wireless communication device through the corresponding through holes of the first flexible laminate substrate and the second flexible laminate substrate.

7. The wireless communication device of claim 6, wherein the flexible circuit board is an operation or indication panel of the wireless communication device.
